(19) United States
(12) Patent Application Publication
(10) Pub. No.: US 2006/0012634 A1
(43) Pub. Date: Jan. 19, 2006

(54) Print cartridge adapter

(76) Inventors: Roger W. Squie, Boise, ID (US); Rickey E. Nichols, Boise, ID (US); John N. Lodal, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/892,593

(22) Filed: Jul. 15, 2004

(51) Int. Cl. B41J 2/14

(52) U.S. Cl. 347/49

(57) ABSTRACT

One embodiment of a print cartridge adapter includes an external surface dimensioned to be received within a print cartridge port of a printing mechanism, and a cavity dimensioned to receive at least a portion of a print cartridge therein.

### BACKGROUND

Print cartridges may be utilized in printing mechanisms to supply ink and/or a printhead for printing an image on a media. A print cartridge may be manufactured with a predetermined shape and/or size which may limit its usefulness and that of a corresponding printing mechanism sized to receive the print cartridge.

### BRIEF DESCRIPTION OF THE DRAWINGS

FIG. 1 is a partial perspective view of one embodiment of a printing mechanism for printing an image.

FIG. 2 is a perspective view of one embodiment of a print cartridge dimensioned to be received with the printing mechanism of FIG. 1.

FIG. 3 is a perspective view of a second embodiment of a print cartridge having dimensions different from the print cartridge shown in FIG. 2.

FIG. 4 is a perspective view of one embodiment of an adapter for receiving one embodiment of a print cartridge therein.

FIG. 5 is a cross sectional side view of one embodiment of the print cartridge of FIG. 3 received within the adapter of FIG. 4.

FIG. 6 is a perspective view of one embodiment of the print cartridge of FIG. 3 received within the adapter of FIG. 4.

FIG. 7 is a cross sectional side view of one embodiment of a print cartridge positioned within one embodiment of an adapter positioned in one embodiment of a printing mechanism.

FIG. 8 is a front view of several embodiments of adapters for receiving different embodiments of print cartridges therein.

### DETAILED DESCRIPTION OF THE DRAWINGS

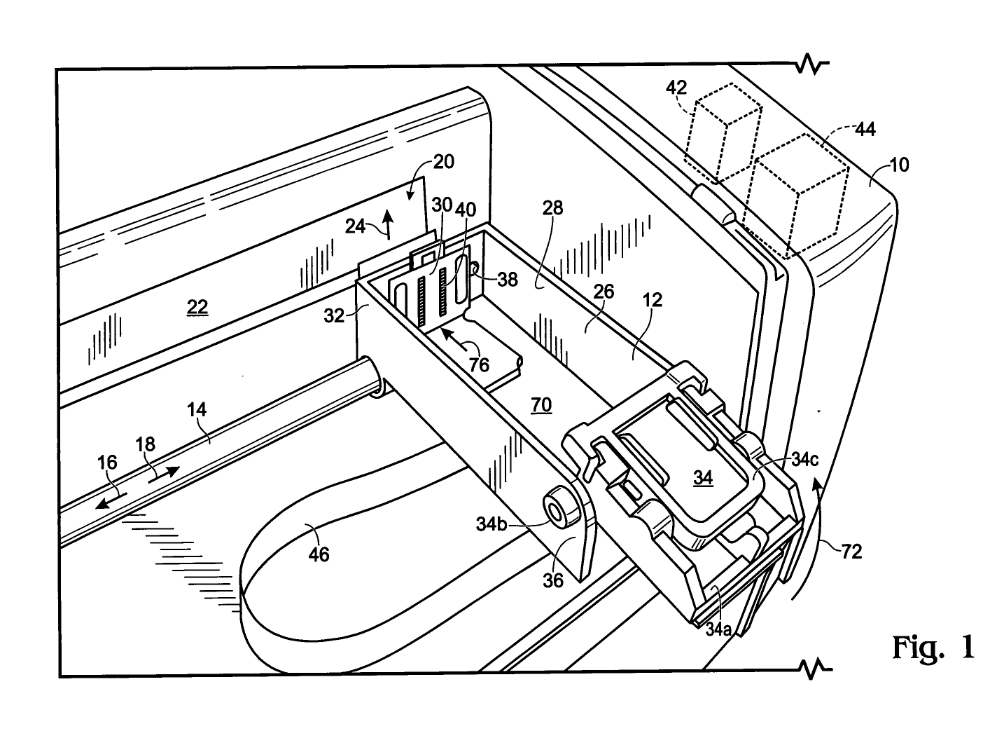

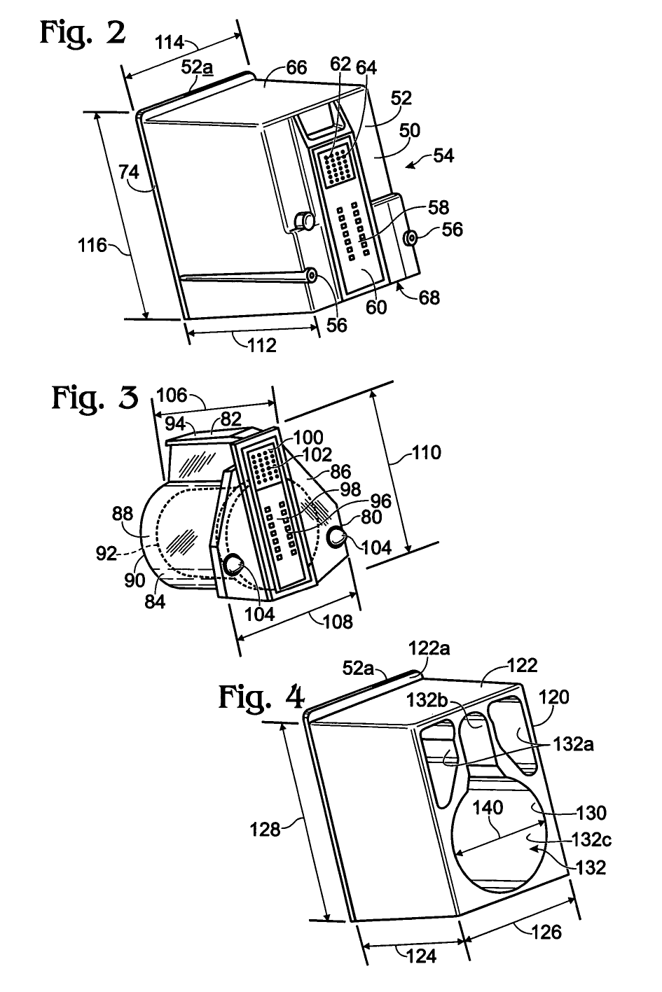

FIG. 1 is a partial perspective view of one embodiment of a printing mechanism 10 for printing an image on one embodiment of a media. Printing mechanism 10 may be a printer, a copier, a facsimile machine or the like, or any combination thereof. The media may be paper, fabric, mylar, transparency foils, cardboard, or any other medium suitable for imaging. In the embodiment shown, printing mechanism 10 may include a print carriage 12 slidably mounted on a carriage rod 14 for movement back and forth in directions 16 and 18 in a printzone 20. As a media 22, such as a sheet of paper, is moved through printzone 20 along a media path 24, print carriage 12 may move a print cartridge (see FIG. 2) back and forth in directions 16 and 18 while ink is ejected from the print cartridge so as to form an image on the media.

Print carriage 12 may define a receptacle 26 for receiving a print cartridge (see FIG. 2) therein, wherein receptacle 26 may define any predetermined shape as desired. In the embodiment shown, receptacle 26 may define a substantially rectangular port or recess 28 having a contact array 30 at a first end 32 and a lock mechanism 34 at a second end 36. In this figure, lock mechanism 34 is shown in an open or unlocked position which may allow removable placement of a print cartridge (see FIG. 2) in receptacle 26. Lock mechanism 34 may comprise a door 34a that may swing upwardly about a cylindrical boss 34b that extends through second end 36 of receptacle 26, and a latch 34c that may secure a print cartridge (see FIG. 2) within receptacle 26. The specific configuration of the lock mechanism 34 can vary and the lock mechanism 34 may not be present in all embodiments. First end 32 may include an alignment datum, such as recesses 38, and contact array 30 may include an electrical contact array 40 operatively connected to a power source 42 (shown schematically) and a control unit 44 (shown schematically) of printing mechanism 10 by an electrical connector such as a flexible cable 46. Contact array 40 may be positioned within or on receptacle 26 in a predetermined position so as to contact a mating contact array on a print cartridge (see FIG. 2). Cable 46 may have a length sufficient so as to allow print carriage 12 to move back and forth across a full width of printzone 20 along carriage rod 14 while retaining electrical contact array 40 in contact with power source 42 and control unit 44.

FIG. 2 is a perspective view of one embodiment of a print cartridge 50 dimensioned to be received within receptacle 26 (see FIG. 1) of print carriage 12. Print cartridge 50 may include an external surface 52 that defines a generally rectangular box shape 54 and may include projections 56 positioned on opposite sides of a contact array 58. Contact array 58 may include an electrical contact region 60 and a nozzle array region, such as an inkjet printhead 62, including nozzles 64 therein (the nozzles are shown generally larger than an actual size and only a few nozzles are shown for ease of illustration). Contact array 58 may be positioned on external surface 52 of print cartridge 50 in a predetermined orientation so as to allow contact between contact array 58 and contact array 30, and therefore, between contact array 58 and power source 42 and control unit 44 of printing mechanism 10 (see FIG. 1). External surface 52 may define an interior ink reservoir 66 operatively connected to printhead 62. External surface 52 of print cartridge 50 may further comprise alocking surface 52a tₜₜhat may mate with lock mechanism 34 of receptacle 26 (see FIG. 1). External surface 52 of print cartridge 50, including projections 56, may be dimensioned and positioned to be received within rectangular recess 28 of receptacle 26 (see FIG. 1) in a single, predetermined orientation. Similarly, contact array 58 of print cartridge 50 may be dimensioned and positioned to be received in contact with contact array 30 of receptacle 26 (see FIG. 1) in a single, predetermined orientation.

Referring to FIGS. 1 and 2, placement of print cartridge 50 in receptacle 26 will be described. Print cartridge 50 may be placed within rectangular recess 28 such that projections 56 of print cartridge 50 are received within recesses 38 of receptacle 26 and such that a lower surface 68 of print cartridge 50 rests on a lower surface 70 of receptacle 26. Door 34a may then be pivoted about boss 34b in a direction 72 such that latch 34c abuts and secures in place a rear surface 52a of print cartridge 50 and urges print cartridge 50 in a direction 76 within receptacle 26. In this locked position, print cartridge 50 may be releasably secured in receptacle 26 in a predetermined position such that printhead 62 is positioned in a predetermined orientation in printzone 20. Moreover, in this locked position contact array 58 of print cartridge 50 may be in electrical contact with electrical contact array 40 of receptacle 26, and thereby in contact with power source 42 and/or control unit 44, such that ink may be ejected from printhead 62 and onto media 22 in printzone 20 to create an image on media 22 as desired.

As described above, print carriage 12, including receptacle 26 having predetermined rectangular recess 28, may be movably mounted on carriage rod 14 and may be connected to power source 42 and control unit 44 of printing mechanism 10 by cable 46. Removal of receptacle 26 and replacement thereof with a receptacle having a shape sized to receive a print cartridge having a different external shape than the shape shown in FIG. 2 may be costly and inefficient. However, it may be desirable to place a print cartridge having a different external shape in receptacle 26 for printing on a media 22 in printzone 20.

FIG. 3 is a perspective view of a second embodiment of a print cartridge 80 having an external shape different from print cartridge 50 shown in FIG. 2. In particular, print cartridge 80 may include an external surface 82 having a first region 84 and a second region 86. In the embodiment shown, first region 84 of external surface 82 may define a generally cylindrical shape, such as a shape having a keyhole or a substantially teardrop shaped cross section including a substantially cylindrical region 90 that may house an ink reservoir 92 therein, and an upwardly extending flange 94. Second region 86 may include a contact array 96 that may include an electrical contact region 98 and a nozzle array region, such as a printhead 100, including nozzles 102 therein. Contact array 96 may be positioned on external surface 88 of print cartridge 80 in an orientation that allows contact between contact array 96 and power source 42 and control unit 44 of printing mechanism 10 (see FIG. 1) when contact array 96 is positioned against contact array 30 of receptacle 26 (see FIG. 1). Second region 86 may further include an alignment datum, such as projections 104, positioned on opposite sides of contact array 96.

The size, shape and position of projections 104 and contact array 96 with respect to each other and with respect to external surface 82 of print cartridge 80 may be substantially similar to the size, shape and position of projections 56 and contact array 30 with respect to each other and with respect to external surface 52 of print cartridge 50. However, external surface 82 of print cartridge 80 may have a shape different than, or smaller than, external surface 52 of print cartridge 50 such that print cartridge 80 may not be easily secured within receptacle 26 of printing mechanism 10. In particular, print cartridge 80 may have a length dimension 106, a width dimension 108 and/or a height dimension 110 that may be smaller than the length, width and/or height dimensions 112, 114, 116, respectively, (see FIG. 2) of print cartridge 50.

FIG. 4 is a perspective view of one embodiment of an adapter 120 for receiving one embodiment of a print cartridge therein. In the embodiment shown, adapter 120 may be adapted for receiving print cartridge 80 (see FIG. 3) therein for placement in receptacle 26 of printing mechanism 10 (see FIG. 1). Adapter 120 may include an external surface 122 having a shape and dimensions that substantially match the shape and dimensions of external surface 52 of print cartridge 50 (see FIG. 2), such as a rectangular box shape. In particular, adapter 120 may include a locking surface 122a, a length dimension 124, a width dimension 126 and a height dimension 128. Locking surface 122a on adapter 120 may substantially correspond to the size, shape and location of locking surface 52a on print cartridge 50 (see FIG. 2) so as to be secured by lock mechanism 34. Width and height dimensions 126 and 128, respectively, of adapter 120, in the embodiment shown, may substantially match the width and height dimensions, 114 and 116, respectively, of print cartridge 50 so that adapter 120 may be secured within receptacle 26 of printing mechanism 10 (see FIG. 1).

Adapter 120 may further include an internal surface 130 that may define a cavity 132 having a shape and dimensions that substantially match the shape and dimensions of external surface 82 of print cartridge 80 (see FIG. 3). In the example embodiment shown in FIG. 4, cavity 132 may have a generally cylindrical shaped cross-section such as a keyhole or a substantially teardrop shaped cross-section sized to receive a keyhole or substantially teardrop shaped external surface of a print cartridge, such as second region 86 of print cartridge 80 (see FIG. 3). In the embodiment shown, length dimension 124 of adapter 120 may be less than length dimension 112 of print cartridge 50 (see FIG. 3). Adapter 120 may further include cavities 132a which may reduce the amount of material that may be utilized during manufacture of adapter 120, and may also reduce the weight of adapter 120.

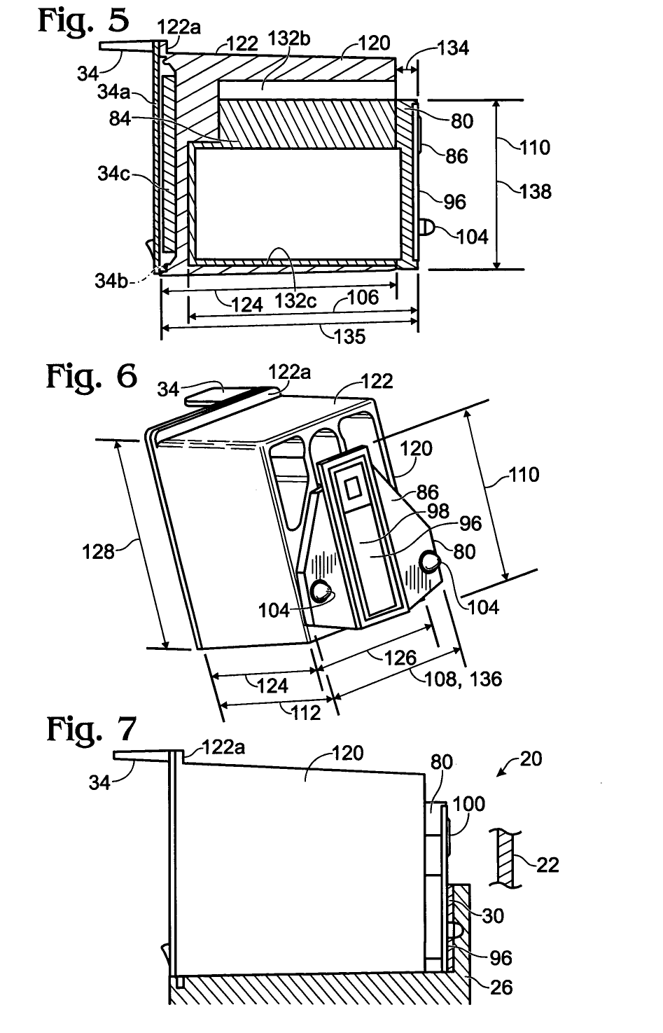

FIGS. 5 and 6 are a cross-sectional side view and a perspective view, respectively, of print cartridge 80 received within adapter 120 of FIG. 4 and showing lock mechanism 34 positioned on external surface 122 of adapter 120. Second region 86 of print cartridge 80 may have a length dimension 134, a width dimension 136 and a height dimension 138. Width dimension 136 of second region 86 of print cartridge 80 may be wider than a width dimension 140 (see FIG. 4) of cavity 132 of adapter 120 such that second region 86 of print cartridge 80 may define a stop position during placement of print cartridge 80 into cavity 132 of adapter 120. An upper region 132b of cavity 132 may be sized to reduce the materials used to manufacture, and may be used to reduce the weight of, adapter 120 such that upwardly extending flange 94 (see FIG. 3) of print cartridge 80 may not entirely fill the upper portion 132b of cavity 132. Nevertheless, upper portion 132b may define a predetermined orientation of flange 94 whereas a lower portion 132c of cavity 132 may retain print cartridge 80 in such predetermined orientation. In another embodiment, first region 84 of print cartridge 80 may have a length substantially the same as a length of cavity 132 such that the length of first region 84 may define a stop position during placement of print cartridge 80 into cavity 132 of adapter 120. Accordingly, when print cartridge 80 is received within adapter 120, printhead 100 may define a generally planar surface that is positioned outwardly of internal surface 130 of adapter 120. Length dimension 134 of second region 86 of print cartridge 80 and length dimension 124 of adapter 120 together may define a length 135 that may be substantially the same as length dimension 112 of print cartridge 50 (see FIG. 2) so that adapter 120, with print cartridge 80 secured therein, may be secured within receptacle 26 of printing mechanism 10 by lock mechanism 34 (see FIG. 1). In other words, length 135 and width 126 of adapter 120, with print cartridge 80 secured therein, may be sized to substantially correspond to a length 26a and a width 26b (see FIG. 1) of receptacle 26 such that adapter 120, with print cartridge 80 secured therein, may be received in receptacle 26. Height 128 of adapter 120 may be sized to substantially correspond to height 34d (see FIG. 1) of lock mechanism 34 (see FIG. 1) such that adapter 120 may be secured in receptacle 26 by lock mechanism 34.

Adapter 120 may be shaped and dimensioned to position projections 104 of second region 86 of print cartridge 80 to be received within recesses 38 (see FIG. 1) of receptacle 26 such that when secured within receptacle 26, contact array 96 of print cartridge 80 may be in contact with contact array 30 of receptacle 26. Accordingly, adapter 120 may be utilized to position a print cartridge 80 in a predetermined position within receptacle 26 when the shape and dimensions of an external surface of print cartridge 80 do not mate with the shape and dimensions of receptacle 26 of printing mechanism 10 (see FIG. 1). In other words, adapter 120 may be utilized to position a print cartridge 80 in a predetermined position within receptacle 26 when the shape and dimensions of an external surface of print cartridge 80 do not match the shape and dimensions of a print cartridge 50 sized to be received within receptacle 26 of printing mechanism 10 (see FIG. 1) without use of an adapter.

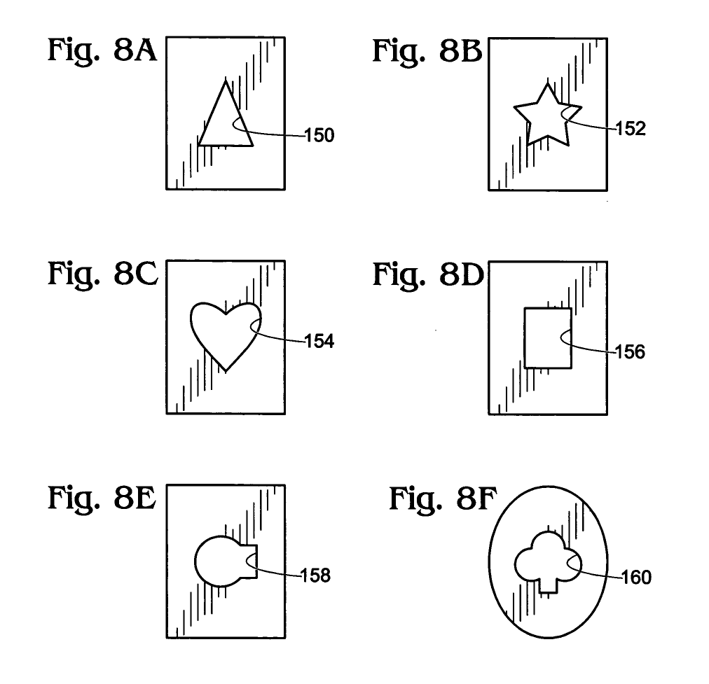

FIG. 7 shows a partial cross-sectional view of print cartridge 80 in adapter 120 and adapter 120 positioned in receptacle 26 such that contact array 96 of print cartridge 80 is in contact with contact array 30 of receptacle 26 of printing mechanism 10 (see FIG. 1). Printhead 100 of print cartridge 80 is shown positioned in printzone 20 for printing an image on a media 22, such as on a sheet of paper.

FIG. 8 is a front view of several embodiments of adapters for receiving different embodiments of print cartridges therein. FIG. 8A shows an adapter having a cavity 150 with triangular shaped cross-section. FIG. 8B shows an adapter having a cavity 152 with a star shaped cross-section. FIG. 8C shows an adapter having a cavity 154 with a heart shaped cross-section. FIG. 8D shows an adapter having a cavity 156 with a rectangular shaped cross-section, wherein cavity 156 may have dimensions smaller than the rectangular dimensions of receptacle 26. FIG. 8E shows an adapter having a cavity 158 with a mushroom shaped cross-section. FIG. 8F shows an adapter having a cylindrical outer shape and a cavity 160 with a clover leaf shaped cross-section.

Other variations and modifications of the concepts described herein may be utilized and fall within the scope of the claims below.

We claim:

1. A print cartridge adapter, comprising:
an external surface dimensioned to be received within a print cartridge port of a printing mechanism; and
a cavity dimensioned to receive at least a portion of a print cartridge therein.

2. An adapter according to claim 1 wherein said external surface defines a substantially rectangular box.

3. An adapter according to claim 1 wherein said cavity defines a substantially key-hole shaped cross-section.

4. An adapter according to claim 1 wherein said cavity is shaped to receive therein a substantially cylindrical ink reservoir portion of a print cartridge.

5. An adapter according to claim 1 wherein said external surface is shaped to receive thereagainst a contact array portion of said print cartridge.

6. An adapter according to claim 1 wherein said cavity is shaped to receive at least a portion of an inkjet print cartridge therein.

7. An adapter according to claim 1 wherein said cavity is shaped to receive therein a substantially cylindrical ink reservoir portion of a print cartridge, and wherein said external surface is shaped to receive thereagainst a nozzle array portion of said print cartridge.

8. A mechanism, comprising:
a carriage;
a print cartridge; and
an adapter having an external surface sized to be received on said carriage and having a cavity sized to receive a portion of said print cartridge.

9. A mechanism according to claim 8 wherein said print cartridge includes an ink reservior that defines a generally cylindrical external shape that mates with said cavity of said adapter.

10. A mechanism according to claim 8 wherein said printhead nozzle array defines a generally planar surface that is positioned outwardly of said cavity 10 when said ink reservoir is positioned therein.

11. A mechanism according to claim 8 wherein said cavity defines a key-hole shaped cross-section and wherein said print cartridge ink reservoir defines a key-hole shaped cross-section that mates with said cavity key-hole shaped cross-section.

12. A mechanism according to claim 8 wherein said cavity of said adapter defines an orientation for receiving said print cartridge therein.

13. A mechanism according to claim 8 wherein said cavity of said adapter defines a cross-sectional shape chosen from one of a triangular shaped cross-section, a star shaped cross-section, a heart shaped cross-section, a rectangular shaped cross-section, and a mushroom shaped cross-section.

14. A printing mechanism, comprising:
an ink reservoir including an external surface having a teardrop shaped cross-section; and
an adapter including a teardrop shaped cavity sized for receiving said ink reservoir in an orientation within said cavity.

15. A printing mechanism according to claim 14 further comprising a print carriage sized to receive said adapter in an d orientation therein.

16. A printing mechanism according to claim 15 wherein said adapter defines a generally rectangular external shape sized to be received within said print carriage in an orientation and wherein said ink reservoir defines a generally round external surface.

17. A printing mechanism according to claim 15 wherein an external shape of said adapter is substantially similar to an external shape of a second ink reservoir sized to be received directly on said print carriage without use of said adapter.

18. A printing mechanism according to claim 14 wherein said ink reservoir includes a nozzle array that extends outwardly of said cavity when said ink reservoir is positioned in said orientation within said cavity.

19. A printing mechanism according to claim 15 further comprising an electrical connection port, and wherein said ink reservoir further includes a contact array that is electrically connected to said electrical connection port when said ink reservoir is positioned in said orientation within said cavity and when said adapter is positioned in said orientation within said print carriage.

20. A printing mechanism according to claim 15 further comprising a locking device that locks said ink reservoir on said print carriage in said orientation.

21. A method of placing a print cartridge in a print carriage, comprising:
placing a print cartridge in an adapter dimensioned to receive said print cartridge in an orientation relative to the adapter; and
placing said adapter in a print carriage dimensioned to receive said adapter.

22. A method according to claim 21 wherein said placing a print cartridge comprises placing a print cartridge having a substantially cylindrical external surface in said adapter such that a nozzle array and a contact array of said print cartridge both extend outwardly from said adapter.

23. A method according to claim 22, further comprising:
electrically connecting a power supply of said printer to said contact array.

24. A method according to claim 23, further comprising:
powering said nozzle array so as to fire ink from an interior of said print cartridge through said nozzle array and onto a media.

25. A printing mechanism, comprising:
a print cartridge port having a first configuration;
a print cartridge having a second configuration; and
means for adapting the print cartridge of the second configuration to fit in the port of the first configuration.

26. A printing mechanism according to claim 25 wherein said first configuration defines a substantially rectangular support receptacle and wherein said second configuration defines a substantially cylindrical ink reservoir.

27. A printing mechanism according to claim 26 wherein said second configuration defines a substantially key-hole shaped cross-section.

28. A printing mechanism according to claim 25, wherein said print cartridge further comprises an electrical connection structure and a plurality of ink ejection nozzles, and wherein said printing mechanism further comprises:
means for powering said ink ejection nozzles, wherein said electrical connection structure is positioned to mate with said means for powering when said print cartridge is positioned within said means for adapting, and said means for adapting is positioned on said print cartridge port.

29. A method of installing an ink cartridge in printing mechanism, comprising:
step for installing an ink cartridge in an adaptive device; and
step for installing said adaptive device, with said ink cartridge therein, in a printing mechanism such that said ink cartridge is positioned to print ink on a media.

30. A method according to claim 29 further comprising:
step for powering said ink cartridge to print ink on a media.

31. A method according to claim 29 wherein said step for installing an ink cartridge comprises installing a substantially teardrop cross-sectional shaped ink cartridge in an adaptive device having a substantially teardrop cross-sectional shaped cavity so as to receive said ink cartridge in an orientation, and wherein said step for installing said adaptive device comprises installing a substantially rectangular cross-sectional shaped adapter in a substantially rectangular cross-sectional shaped print cartridge port so as to receive said ink cartridge in an orientation.

32. An adapter for positioning a print cartridge in a printer, comprising:
an external surface dimensioned to be received within a print cartridge port in an orientation; and
an internal surface that defines an orientation for receiving therein a print cartridge such that an ink communication structure of said print cartridge is positioned in an orientation for printing on a media.

33. An adapter according to claim 32 wherein said ink communication structure includes an electrical contact array and a nozzle array, and wherein when said ink cartridge is in said orientation said electrical contact array is positioned to be in electrical contact with a print controller of said printer and said nozzle array is positioned to eject ink through said nozzle array into a print zone of said printer.

34. An adapter according to claim 32 wherein said internal surface defines a cross-sectional shape chosen from one of the following: a triangular shaped cross-section, a star shaped cross-section, a heart shaped cross-section, a rectangular shaped cross-section, and a mushroom shaped cross-section.

35. A printing mechanism, comprising:
a print carriage sized to receive thereon a first print cartridge having first external dimensions and a first contact array in a first position on said first external dimensions;
a print cartridge having a second contact array and second external dimensions different from said first external dimensions; and
an adapter having an external surface with dimensions that are substantially the same as said first external dimensions of said first print cartridge, and an internal surface sized to receive said print cartridge having said second external dimensions, such that when said print cartridge is positioned within said adapter and received on said print carriage, said second contact array is positioned in said first position.

36. A printing mechanism according to claim 35 wherein said first and second contact arrays both comprise electrical connection ports.

37. A printing mechanism according to claim 35 wherein said first and second contact arrays both comprise nozzle arrays.

38. A printing mechanism according to claim 35 wherein said printing mechanism comprises one or more of a printer, a copier, a scanner and a facsimile machine.

39. A mechanism, comprising:
a carriage having opposing sidewalls;
a print cartridge; and
an adapter surrounding at least a portion of the print cartridge and disposed between the carriage sidewalls.
